(19) United States
(12) Patent Application Publication
(10) Pub. No.: US 2021/0192880 A1
(43) Pub. Date: Jun. 24, 2021

(54) BANKNOTE COUNTING METHOD OF BANKNOTE COUNTING DEVICE, AND BANKNOTE COUNTING DEVICE

(71) Applicant: Comix Business Machine(Shenzhen)Co.,Ltd., Shenzhen (CN)

(72) Inventor: Qinpeng CHEN, Shenzhen (CN)

(21) Appl. No.: 16/757,747

(22) PCT Filed: Nov. 27, 2017
(86) PCT No.: PCT/CN2017/113136

§ 371 Date: Apr. 20, 2020

(51) Int. Cl. G07D 11/50; G07G 1/01

(52) U.S. Cl. CPC G07D 11/50; G07G 1/01

(57) ABSTRACT

A banknote counting method of a banknote counting device (100) is provided. The banknote counting device (100) is provided with a plurality of banknote storing regions, and the banknote counting method includes the following steps: detecting the denomination of a banknote currently counted in real time during a banknote counting process (S10); putting the banknote currently counted into a corresponding banknote storing region according to the denomination (S20); determining whether the banknote of the denomination is the first one in the banknote counting process (S30); if yes, calculating the current quantity of the banknote in the banknote storing region (S40); and if not, adding “1” to the original quantity of the banknote in the banknote storing region to calculate the current quantity of the banknote in the banknote storing region (S50). The banknote counting device (100) and the method can classify and count the banknotes to be counted according to the denominations, and can calculate and display in real time the quantity of counted banknotes of each denomination, the amount of the banknotes of each denomination, and the total quantity and total amount of all the banknotes after counting, thereby greatly reducing the workload of bank staff and improving user experience.

### CROSS-REFERENCE TO RELATED APPLICATION

This application is a national stage application of PCT Application No. PCT/CN2017/113136. This Application claims priority from PCT Application No. PCT/CN2017/113136, filed Nov. 27, 2017, the content of which is incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates to the field of electronic devices, and more particularly to a banknote counting method of banknote counting device and a banknote counting device.

### BACKGROUND

With the continuous development of bank's financial and cash business, a large amount of cash needs to be counted by banknote counting devices. Further, in order to record the handling of customer's cash, bank staff needs to report the counting results after counting.

At present, financial special banknote counting devices in the banks can only achieve the function of banknotes counting. The banknote counting devices cannot classify and count banknotes of various denominations.

Therefore, a heretofore unaddressed need exists in the art to address the aforementioned deficiencies and inadequacies.

### SUMMARY

### Technical Problem

The present disclosure is to solve the technical problem that the banknote counting device in the prior art cannot classify and count banknotes of various denominations.

### Technical Solution

In order to achieve the above aim, the present disclosure provides a banknote counting method of a banknote counting device. The banknote counting device is provided with a plurality of banknote storing regions, and the banknote counting method includes:

detecting the denomination of a banknote currently counted in real time during a banknote counting process;

putting the banknote currently counted into a corresponding banknote storing region according to the denomination;

determining whether the banknote of the denomination is the first one in the banknote counting process;

calculating the current quantity of the banknote in the banknote storing region if the banknote of the denomination is the first one in the banknote counting process, and the current quantity of the banknote in the banknote storing region is “1”; and

adding “1” to the original quantity of the banknote in the banknote storing region to calculate the current quantity of the banknote in the banknote storing region if the banknote of the denomination is not the first one in the banknote counting process.

Preferably, the banknote counting method further includes:

calculating the current amount of the banknote in the banknote storing region according to the denomination of the banknote currently counted and the current quantity of the banknote in the banknote storing region after the current quantity of the banknote in the banknote storing region is calculated.

Preferably, after the operation of calculating the current amount of the banknote in the banknote storing region, the banknote counting method further includes:

displaying the current quantity of the banknote and the current amount of the banknote in the banknote storing region.

Preferably, after the operation of displaying the current quantity of the banknote and the current amount of the banknote in the banknote storing region, the banknote counting method further includes:

determining whether the banknote currently counted is the last one in the banknote counting process; and

calculating and displaying the total quantity and total amount of all the banknotes counted in the banknote counting process according to the quantity and amount of banknote in each banknote storing region if the banknote currently counted is the last one in the banknote counting process.

Preferably, after the operation of calculating and displaying the total quantity and total amount of all the banknotes counted in the banknote counting process, the banknote counting method further includes:

placing all the banknotes together according to the order of the size of denomination of the banknotes.

In order to achieve the above aim, the present disclosure further provides a banknote counting device. The banknote counting device is provided with a plurality of banknote storing regions, and the banknote counting device includes:

a detecting module, configured for detecting the denomination of a banknote currently counted in real time during a banknote counting process;

a storing module, configured for putting the banknote currently counted into a corresponding banknote storing region according to the denomination;

a determining module, configured for determining whether the banknote of the denomination is the first one in the banknote counting process;

a calculating module, configured for calculating the current quantity of the banknote in the banknote storing region if the banknote of the denomination is the first one in the banknote counting process, and the current quantity of the banknote in the banknote storing region is “1”; and configured for adding “1” to the original quantity of the banknote in the banknote storing region to calculate the current quantity of the banknote in the banknote storing region if the banknote of the denomination is not the first one in the banknote counting process.

Preferably, the calculating module is further configured for calculating the current amount of the banknote in the banknote storing region according to the denomination of the banknote currently counted and the current quantity of the banknote in the banknote storing region after the current quantity of the banknote in the banknote storing region is calculated.

Preferably, the banknote counting device further includes:

a displaying module, configured for displaying the current quantity of the banknote and the current amount of the banknote in the banknote storing region.

Preferably, the determining module is further configured for determining whether the banknote currently counted is the last one in the banknote counting process after the current quantity of the banknote and the current amount of the banknote in the banknote storing region is displayed;

the calculating module is further configured for calculating the total quantity and total amount of all the banknotes counted in the banknote counting process according to the quantity and amount of banknote in each banknote storing region if the banknote currently counted is the last one in the banknote counting process.

The displaying module is further configured for displaying the total quantity and total amount of all the banknotes counted in the banknote counting process.

Preferably, the banknote counting device further includes:

a gathering module, configured for placing all the banknotes together according to the order of the size of denomination of the banknotes after the total quantity and total amount of all the banknotes counted in the banknote counting process are displayed.

The banknote counting method and the banknote counting device provided by the present disclosure can classify and count the banknotes to be counted according to the denominations, and can calculate and display in real time the quantity of counted banknotes of each denomination, the amount of the banknotes of each denomination, and the total quantity and total amount of all the banknotes after counting, thus greatly reducing the workload of bank staff and improving user experience.

### BRIEF DESCRIPTION OF THE DRAWINGS

The accompanying drawings illustrate one or more embodiments of the present disclosure and, together with the written description, serve to explain the principles of the invention. Wherever possible, the same reference numbers are used throughout the drawings to refer to the same or like elements of an embodiment.

FIG. 1 is a flowchart of a banknote counting method in accordance with a first embodiment of the present disclosure;

FIG. 2 is a schematic view of function modules of a banknote counting device in accordance with the first embodiment of the present disclosure;

FIG. 3 is a schematic view of function modules of a banknote counting device in accordance with a second embodiment of the present disclosure;

FIG. 4 is a schematic view of function modules of a banknote counting device in accordance with a fourth embodiment of the present disclosure.

The realization of the purpose, the features, and the advantages of the present disclosure will be further described with reference to the accompanying drawings.

### DETAILED DESCRIPTION OF THE EMBODIMENTS

The present disclosure will now be described more fully hereinafter with reference to the accompanying drawings, in which exemplary embodiments of the present disclosure are shown. The present disclosure may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The technical solutions of the embodiments of the present disclosure will be described in the following with reference to the accompanying drawings. It should be understood that the preferred embodiments described herein are only used to illustrate and explain the present disclosure, and are not to limit the present disclosure. In the case of no conflict, the embodiments and features in the embodiments can be combined with each other.

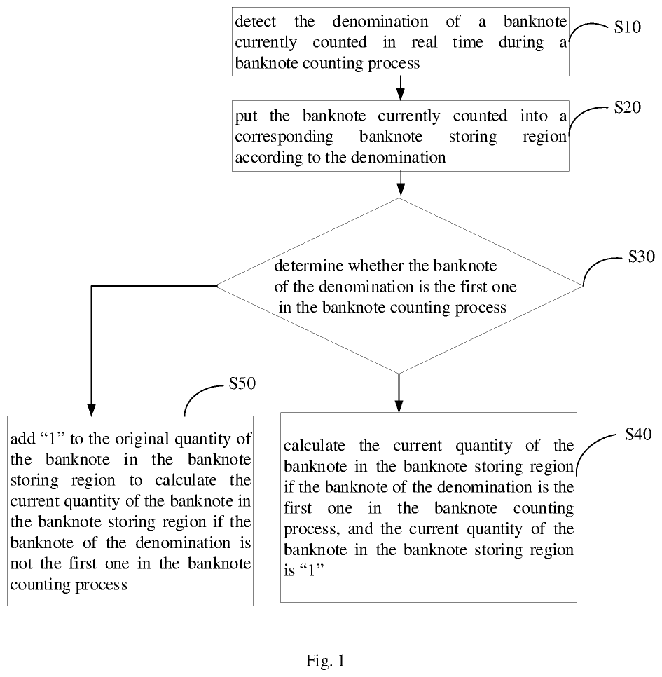

The present disclosure provides a first embodiment for the banknote counting method. The banknote counting device is provided with a plurality of banknote storing regions. Please referring to FIG. 1, which is a flowchart of the banknote counting method in accordance with the first embodiment. In the first embodiment, the banknote counting method includes:

Step S10, the denomination of a banknote currently counted is detected in real time during a banknote counting process.

In the exemplary embodiment, the denominations of the banknotes include: 0.1 yuan, 0.5 yuan, 1 yuan, 5 yuan, 10 yuan, 20 yuan, 50 yuan, and 100 yuan. The quantity of the banknote storing regions is eight, that is, for each denomination of banknotes, the banknote counting device is provided with a corresponding banknote storing region.

Step 20, the banknote currently counted is put into a corresponding banknote storing region according to the denomination of the banknote.

Step 30, whether the banknote of the denomination is the first one in the banknote counting process is determined.

Step 40, if the banknote of the denomination is the first one in the banknote counting process, the current quantity of the banknote in the banknote storing region is calculated, and the current quantity of the banknote in the banknote storing region is “1”.

Step 50, if the banknote of the denomination is not the first one in the banknote counting process, the original quantity of the banknote in the banknote storing region is added with “1” to obtain the current quantity of the banknote in the banknote storing region.

Further, the present disclosure provides a second embodiment for the banknote counting method of the banknote counting device. The second embodiment is improved on the basis of the first embodiment. The improvement lies in that the banknote counting method further includes: calculating the current amount of the banknote in the banknote storing region according to the denomination of the banknote currently counted and the current quantity of the banknote in the banknote storing region after the current quantity of the banknote in the banknote storing region is calculated.

In the second embodiment, after the current amount of the banknote in the banknote storing region is calculated, the banknote counting method further includes: displaying the current quantity of the banknote and the current amount of the banknote in the banknote storing region.

Further, the present disclosure provides a third embodiment for the banknote counting method of the banknote counting device. The third embodiment is improved on the basis of the second embodiment. The improvement lies in that after the current quantity of the banknote and the current amount of the banknote in the banknote storing region is displayed, the banknote counting method further includes: determining whether the banknote currently counted is the last one in the banknote counting process; and calculating and displaying the total quantity and total amount of all the banknotes counted in the banknote counting process according to the quantity and amount of banknote in each banknote storing region if the banknote currently counted is the last one in the banknote counting process.

Further, the present disclosure provides a fourth embodiment for the banknote counting method of the banknote counting device. The fourth embodiment is improved on the basis of the third embodiment. The improvement lies in that after the total quantity and total amount of all the banknotes counted in the banknote counting process are calculated and displayed, the banknote counting method further includes: placing all the banknote in total according to the order of the size of denomination of the banknotes.

The banknote counting device described in the exemplary embodiment is further provided with a gathering storage region. The operation of placing all the banknotes together according to the order of the size of denomination of the banknotes is specifically carried out as follows: the banknotes in the banknote storing regions are sequentially acquired according to the order of size of denomination, and the acquired banknotes are placed in the gathering storage region, so that all the counted banknotes are placed in the gathering storage region in order.

The banknote counting method of the banknote counting device provided by the present disclosure can classify and count the banknotes to be counted according to the denominations, and can calculate and display in real time the quantity of counted banknotes of each denomination, the amount of the banknotes of each denomination, and the total quantity and total amount of all the banknotes after counting, thus greatly reducing the workload of bank staff and improving user experience.

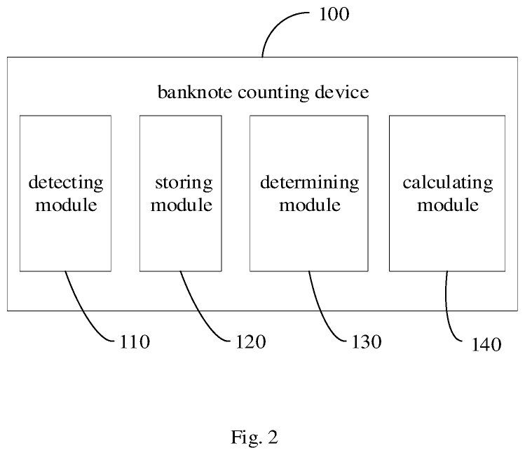

The present disclosure provides a banknote counting device. The banknote counting device is provided with a plurality of banknote storing regions. Please referring to FIG. 2, which is a schematic view of function modules of the banknote counting device in accordance with a first embodiment of the present disclosure. In the first embodiment, the banknote counting device 100 includes a detecting module 110, a storing module 120, a determining module 130, and a calculating module 140. The detecting module 110 is configured for detecting the denomination of a banknote currently counted in real time during a banknote counting process. The storing module 120 is configured for putting the banknote currently counted into a corresponding banknote storing region according to the denomination. The determining module 130 is configured for determining whether the banknote of the denomination is the first one in the banknote counting process. The calculating module 140 is configured for calculating the current quantity of the banknote in the banknote storing region if the banknote of the denomination is the first one in the banknote counting process, and the current quantity of the banknote in the banknote storing region is “1”; and configured for adding “1” to the original quantity of the banknote in the banknote storing region to calculate the current quantity of the banknote in the banknote storing region if the banknote of the denomination is not the first one in the banknote counting process.

In the exemplary embodiment, the denominations of the banknotes include: 0.1 yuan, 0.5 yuan, 1 yuan, 5 yuan, 10 yuan, 20 yuan, 50 yuan, and 100 yuan. The quantity of the banknote storing regions is eight, that is, for each denomination of banknotes, the banknote counting device is provided with a corresponding banknote storing region.

Further, the present disclosure provides a second embodiment of the banknote counting device. The second embodiment is improved on the basis of the first embodiment. The improvement lies in that the calculating module 140 is further configured for calculating the current amount of the banknote in the banknote storing region according to the denomination of the banknote currently counted and the current quantity of the banknote in the banknote storing region after the current quantity of the banknote in the banknote storing region is calculated.

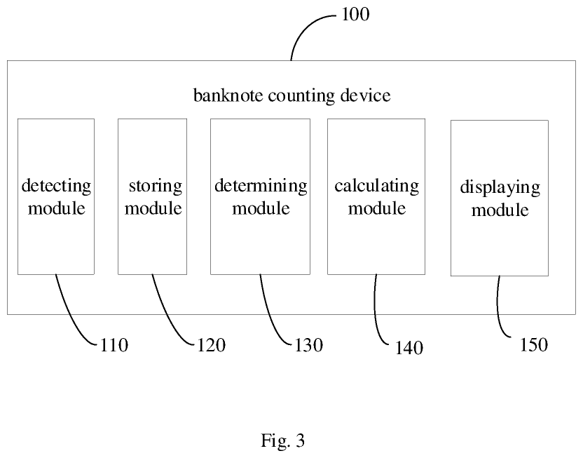

Referring to FIG. 3, which is a schematic view of function modules of the banknote counting device in accordance with a second embodiment of the present disclosure. In the exemplary embodiment, the banknote counting device 100 further includes a displaying module 150. The displaying module 150 is configured for displaying the current quantity of the banknote and the current amount of the banknote in the banknote storing region.

Further, the present disclosure provides a third embodiment of the banknote counting device. The third embodiment is improved on the basis of the second embodiment. The improvement lies in that after the current quantity of the banknote and the current amount of the banknote in the banknote storing region is displayed by the displaying module 150, the determining module 130 is further configured for determining whether the banknote currently counted is the last one in the banknote counting process. The calculating module 140 is further configured for calculating the total quantity and total amount of all the counted banknotes in the banknote counting process according to the quantity and amount of banknote in each banknote storing region if the banknote currently counted is the last one in the banknote counting process. The displaying module 150 is further configured for displaying the total quantity and total amount of all the counted banknotes in the banknote counting process.

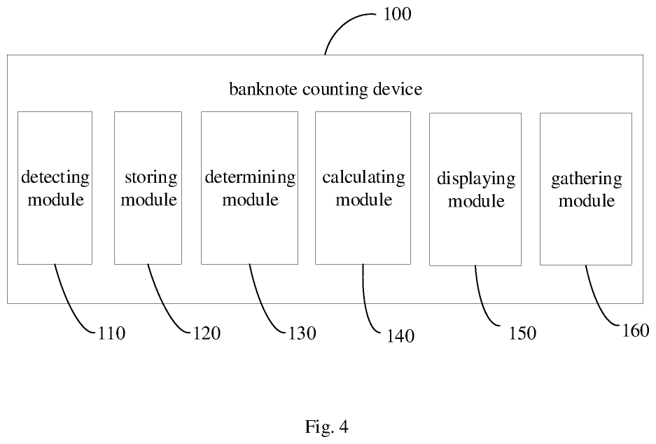

Further, the present disclosure provides a fourth embodiment of the banknote counting device. Please referring to FIG. 4, which is a schematic view of function modules of the banknote counting device in accordance with the fourth embodiment. The fourth embodiment is improved on the basis of the third embodiment. The improvement lies in that the banknote counting device 100 further includes a gathering module 160. The gathering module is configured for placing all the banknotes together according to the order of the size of denomination of the banknotes after the total quantity and total amount of all the banknotes counted in the banknote counting process are displayed by the displaying module 150.

The banknote counting device 100 described in the exemplary embodiment is further provided with a gathering storage region. The gathering module 160 is specifically configured for sequentially acquiring the banknotes in the banknote storing regions according to the order of size of denomination of the counted banknotes, and placing the acquired banknotes in the gathering storage region, to allow all the counted banknotes be placed in the gathering storage region in order.

The banknote counting device 100 provided by the present disclosure can classify and count the banknotes to be counted according to the denominations, and can calculate and display in real time the quantity of counted banknotes of each denomination, the amount of the banknotes of each denomination, and the total quantity and total amount of all the banknotes after counting, thereby greatly reducing the workload of bank staff and improving user experience.

What has been described above are only preferred embodiments of the present disclosure, and are not considering to limit the protection scope of the present disclosure. And any equivalent changes made in structures or processes with regard to the description and drawings of the present disclosure, directly or indirectly used in other related technical fields, are all included in the protection scope of the present disclosure.

The foregoing description of the exemplary embodiments of the present disclosure has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A banknote counting method of a banknote counting device, wherein the banknote counting device is defined with a plurality of banknote storing regions, and the banknote counting method comprises:
detecting the denomination of a banknote currently counted in real time during a banknote counting process;
putting the banknote currently counted into a corresponding banknote storing region according to the denomination;
determining whether the banknote of the denomination is the first one in the banknote counting process;
calculating the current quantity of the banknote in the banknote storing region if the banknote of the denomination is the first one in the banknote counting process, and the current quantity of the banknote in the banknote storing region is “1”; and
adding “1” to the original quantity of the banknote in the banknote storing region to calculate the current quantity of the banknote in the banknote storing region if the banknote of the denomination is not the first one in the banknote counting process.

2. The banknote counting method according to claim 1, further comprising:
calculating the current amount of the banknote in the banknote storing region according to the denomination of the banknote currently counted and the current quantity of the banknote in the banknote storing region after the current quantity of the banknote in the banknote storing region is calculated.

3. The banknote counting method according to claim 2, wherein after the operation of calculating the current amount of the banknote in the banknote storing region, the banknote counting method further comprises:
displaying the current quantity of the banknote and the current amount of the banknote in the banknote storing region.

4. The banknote counting method according to claim 3, wherein after the operation of displaying the current quantity of the banknote and the current amount of the banknote in the banknote storing region, the banknote counting method further comprises:
determining whether the banknote currently counted is the last one in the banknote counting process; and
calculating and displaying the total quantity and total amount of all the banknotes counted in the banknote counting process according to the quantity and amount of banknote in each banknote storing region if the banknote currently counted is the last one in the banknote counting process.

5. The banknote counting method according to claim 4, wherein after the operation of calculating and displaying the total quantity and total amount of all the banknotes counted in the banknote counting process, the banknote counting method further comprises:
placing all the banknotes together according to the order of the size of denomination of the banknotes.

6. A banknote counting device, wherein the banknote counting device is defined with a plurality of banknote storing regions, and the banknote counting device comprises:
a detecting module, configured for detecting the denomination of a banknote currently counted in real time during a banknote counting process;
a storing module, configured for putting the banknote currently counted into a corresponding banknote storing region according to the denomination;
a determining module, configured for determining whether the banknote of the denomination is the first one in the banknote counting process; and
a calculating module, configured for calculating the current quantity of the banknote in the banknote storing region if the banknote of the denomination is the first one in the banknote counting process, and the current quantity of the banknote in the banknote storing region is “1”; and configured for adding “1” to the original quantity of the banknote in the banknote storing region to calculate the current quantity of the banknote in the banknote storing region if the banknote of the denomination is not the first one in the banknote counting process.

7. The banknote counting device according to claim 6, wherein,
the calculating module is further configured for calculating the current amount of the banknote in the banknote storing region according to the denomination of the banknote currently counted and the current quantity of the banknote in the banknote storing region after the current quantity of the banknote in the banknote storing region is calculated.

8. The banknote counting device according to claim 7, further comprising:
a displaying module, configured for displaying the current quantity of the banknote and the current amount of the banknote in the banknote storing region.

9. The banknote counting device according to claim 8, wherein,
the determining module is further configured for determining whether the banknote currently counted is the last one in the banknote counting process after the current quantity of the banknote and the current amount of the banknote in the banknote storing region are displayed;
the calculating module is further configured for calculating the total quantity and total amount of all the banknotes counted in the banknote counting process according to the quantity and amount of banknote in each banknote storing region if the banknote currently counted is the last one in the banknote counting process; and
the displaying module is further configured for displaying the total quantity and total amount of all the banknotes counted in the banknote counting process.

10. The banknote counting device according to claim 9, wherein the banknote counting device further comprises:
a gathering module, configured for placing all the banknotes together according to the order of the size of denomination of the banknotes after the total quantity and total amount of all the counted banknotes in the banknote counting process are displayed.
